(19) United States
(12) Patent Application Publication
(10) Pub. No.: US 2025/0359534 A1
(43) Pub. Date: Nov. 27, 2025

(54) Pet Interactive System

(71) Applicant: Pet Interactive, Inc., Wyomissing, PA (US)

(72) Inventors: Geoff DeWire, Wyomissing, PA (US); David Krieg, Blue Bell, PA (US)

(73) Assignee: Pet Interactive, Inc., Wyomissing, PA (US)

(21) Appl. No.: 18/673,815

(22) Filed: May 24, 2024

(51) Int. Cl. A01K 29/00

(52) U.S. Cl. CPC A01K 29/00

(57) ABSTRACT

A pet interactive system includes a pet health module with a plurality of selectable topics. The pet interactive system having a criteria and narrowing a plurality of advertisements by the criteria for display once a video has concluded.

### FIELD OF THE INVENTION

The present invention pertains to a pet interactive system which interacts with the veterinary office's management system, providing access to and displaying tailored pet-specific health information for each visit.

### BACKGROUND

A difficulty arises for pet owners when attending a veterinary visit for their pet. Generally, the normal pet owner does not have the educational aptitude to know the anatomy of a canine or feline. More importantly, when a pet needs additional care, this requires the pet owner to understand the underlining illness cause and the reasoning of the procedures needed to rectify the cause. Some medical procedures are complex and difficult to explain in words alone, thus, there is a need to aid pet owners in providing knowledge for simple and complex procedures for their individual pet.

### SUMMARY

A pet interactive system generally includes a computing device having a screen and a network traffic information on a database server. A content management module coupling to the computing device through a network interface, permitting a developer to create or change content displayed on the screen. A plurality of vendor functions communicating with a vendor management module of the developer. The content management module further permits and communicates with a pet health module having a plurality of selectable topics displayable on the screen, each selectable topic of the plurality of selectable topics corresponds to a video. An advertisement customization module permits an administrator a select/deselect product button corresponding to a sellable product of a vendor which communicates with the computing device. A criteria utilized by an algorithm when determining an appropriate advertisement to play once the video concludes, the criteria determines from a plurality of approved advertisements by the administrator, a nature of an advertisement, a review of a number of times the advertisement is played through a specified time frame, and narrows down the plurality of approved advertisements to present the appropriate advertisement to correspond to a videos conclusion.

### BRIEF DESCRIPTION OF DRAWINGS

In the following exemplary embodiments, the present invention is described in more detail with references to the drawings in which:

FIG. 1 illustrates a schematic diagram of hardware infrastructure for the pet interactive system according to the invention;

FIG. 2 illustrates a schematic diagram of the pet interactive system according to the invention;

FIG. 3 illustrates another schematic diagram of the pet interactive system according to the invention of FIG. 2;

FIG. 4 illustrates a schematic view of the pet interactive system according to an exemplary embodiment of the invention;

FIG. 5 illustrates another schematic view of the pet interactive system according to an exemplary embodiment of the invention of FIG. 4;

FIG. 6 illustrates another exemplary schematic view of the pet interactive system;

FIG. 7 illustrates another exemplary schematic view of the pet interactive system;

FIG. 8 illustrates another exemplary schematic view of the pet interactive system of FIG. 7;

FIG. 9 illustrates another exemplary schematic view of the pet interactive system of FIG. 8;

FIG. 10 illustrates another exemplary schematic view of the pet interactive system of FIG. 9;

FIG. 11 illustrates another exemplary schematic view of the pet interactive system of FIG. 10;

FIG. 12 illustrates another exemplary schematic view of the pet interactive system of FIG. 11;

FIG. 13 illustrates another exemplary schematic view of the pet interactive system of FIG. 7;

FIG. 14 illustrates another exemplary schematic view of the pet interactive system of FIG. 8;

FIG. 15 illustrates another exemplary schematic view of the pet interactive system of FIG. 9;

FIG. 16 illustrates another exemplary schematic view of the pet interactive system of FIG. 10;

FIG. 17 illustrates a schematic diagram of the pet interactive system according to an exemplary embodiment of the invention;

FIG. 18 illustrates another schematic diagram of the pet interactive system according to an exemplary embodiment of the invention of FIG. 17; and

FIG. 19 illustrates another schematic diagram of the pet interactive system according to an exemplary embodiment of the invention of FIG. 18.

### DETAILED DESCRIPTION OF THE EMBODIMENTS

With reference to the Figures, a pet interactive system 1 according to the invention is shown.

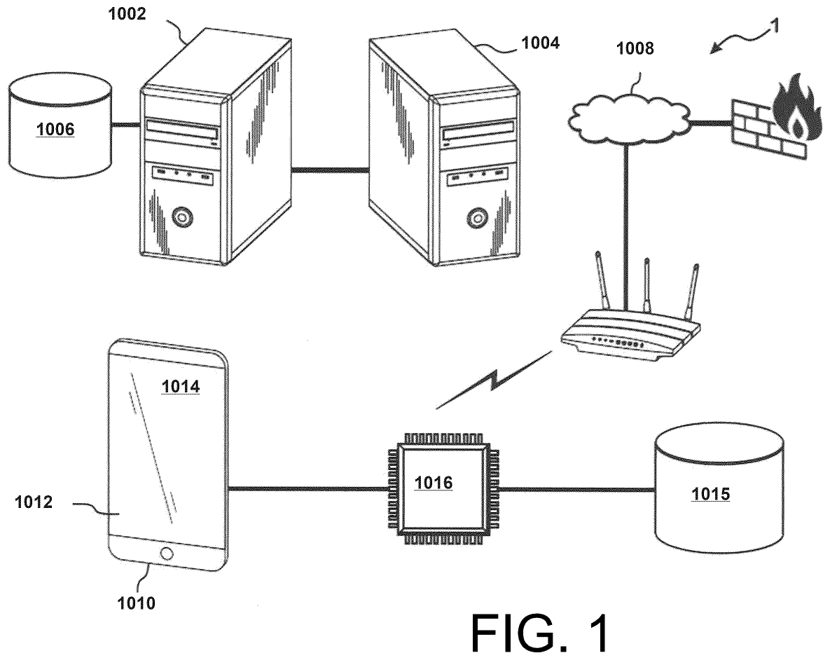

As shown in FIG. 1, a pet interactive system 1 according to the invention generally includes an application site. One of ordinary skill in the art would understand the applicant's design is not the exclusive embodiment. In the exemplary embodiment, the application site is designed to work on any suitable browser such as internet Explorer 10+, and the most up-to-date versions of Chrome, Safari and Firefox across all major operating systems and updated device platforms for example Android and IOS. One of ordinary skill in the art would understand the applicant's design is not the exclusive embodiment.

Hardware infrastructure for an embodiment of the pet interactive system 1 will be described. In an exemplary embodiment, the pet interactive system 1 is built on a network router (for instance, a wireless router) and connected to a database server, while also utilizing known hardware components, including a web server, a firewall, a network, and the computing device.

Referring first to FIG. 1, which is a broad overview of an exemplary hardware infrastructure for an embodiment of the pet interactive system 1 will be described. To perform the aforementioned and other functions, the pet interactive system 1 generally includes a plurality of integrated system servers 1002, 1004 with one or more databases 1006 (i.e., internal information repository), a network interface 1008 accessible through various known communication protocols, such as TCP/IP, cellular protocols including GSM, Wi-Fi, Wi-Max, or other wireless communications technologies or combination of wired or wireless channels, network security devices (where necessary), and a computing device 1010 having a processing unit 1016 and memory 1015.

In the exemplary embodiment, the pet interactive system 1 allows a user to access a plurality of system files that includes data, such as information and images, through the computing device 1010 and a network traffic information on the database server 1002 (i.e., SQLServer or PostgreSQL (also known as Postgres) or newer) that connects to a web server 1004. The web server 1004 functions as a way for network interface 1008 to communicate to the database server 1002 through known application-programming interface (API) between the computing device 1010 and the database server 1002. A firewall may be used for security purposes such as, but is not limited to, blocking unauthorized access to the web server 1004 and permitting unauthorized communication thereto. The pet interactive system 1 is designed to run through the computing device 1010 through a pet interactive module that can be downloaded over personal area networks (PANs), local area networks (LANs), campus area networks (CANs), wide area networks (WANs), metropolitan area networks (MANs) and any new networking system developed in the future. One skilled in the art should appreciate that the pet interactive system 1 can be maintained solely through the computing device 1010, as the pet interactive system modules can be pre-loaded to the computing device 1010.

The computing device 1010 as depicted having a processor 1016 for performing the necessary calculations and performing the actions for the pet interactive system module having a plurality of service modules within the pet interactive module, and also having memory 1015, configured for storing and accessing the pet interactive system files, including a plurality of front-end user functions, a plurality of vendor user functions, a plurality of administration user functions and a plurality of developer user functions which may be employed in the pet interactive system simulation.

In the shown embodiment, the user may connect to the network interface 1008 using the computing device 1010 through the router for instance. One skilled in the art would appreciate that other hardware and protocol designs are possible as long as such modifications would not divert from the spirit of the invention.

In an exemplary embodiment, as shown in FIG. 1, the computing device 1010 generally includes the general user interface 1014, the memory device 1015, and the processor 1016. In the shown embodiment, the computing device is a tablet computer or mobile phone with a touchscreen display 1012. The touchscreen display 1012 uses finger or stylus gestures to navigate the general user interface (GUI) 1014. However, one skilled in the art should appreciate that other implements could be used; including a computer mouse, a keyboard, or joystick. In fact, one skilled in the art should appreciate that the computing device 1010 is a physical computer and could be, but not limited to, a desktop computer, a laptop computer, or a cell phone, and utilize a downloaded app or web browser. The memory device 1015 is a storage device having computer components and recording media used to retain digital data. The processor 1016 is a central processing unit (CPU) that manipulates data stored in the memory device 1015 by performing computations.

In an alternative embodiment, the pet interactive system files, including the front-end user functions, the vendor user functions, the administration user functions and the developer user functions, and programming language necessary for performing the simulation may be loaded into the memory device 1015 of the computing device 1010, and performable by the processor 1016, utilizing user inputs through the general user interface 1014. In such an embodiment, there may be no need for communication through the network interface 1008 to communicate with external devices (e.g., servers 1002, 1004) through a network router.

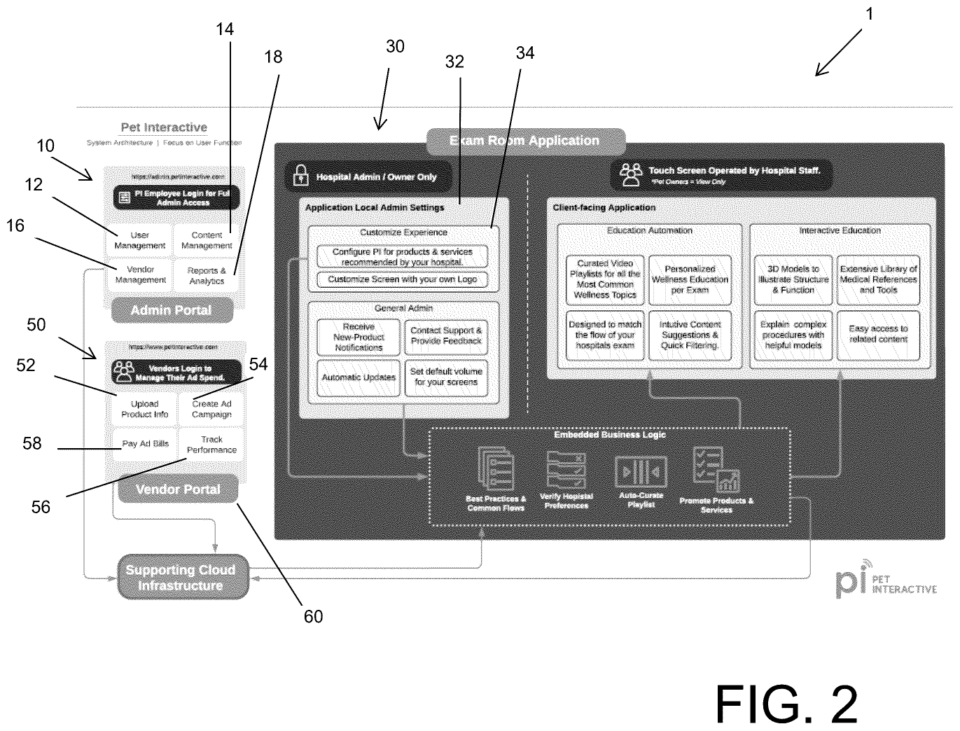

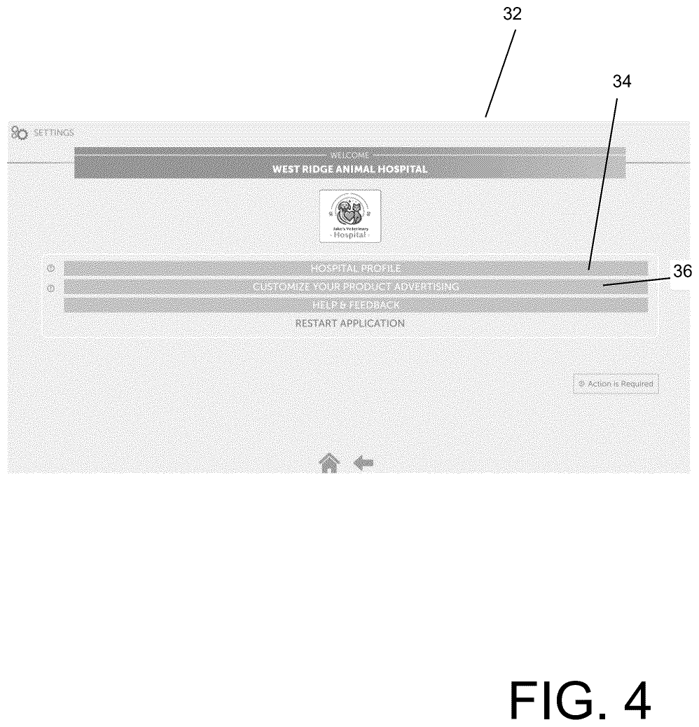

In the exemplary embodiment, as shown in FIGS. 2-4, the plurality of developer user functions portal 10 include a user management module 12, a content management module 14, a vendor management module 16 and a report and analytics module 18.

In the exemplary embodiment, the user management module 12 provides the developer/owner the ability to provide an administrator access to the pet interactive system 1. Specifically, the ability to allow administrators of a hospital to interact with the pet interactive system 1. The administrator's functions and interaction with the pet interactive system 1 will be discussed below.

In the exemplary embodiment, the content management module 14 permits the developer to create/update or change content displayed in the pet interactive system 1. Additionally, the developer is permitted to change the visual display of the pet interactive system 1. One skilled in the art would understand the applicant's design is not the exclusive embodiment.

In the exemplary embodiment, the vendor management module 16 permits the developer user to maintain or update appropriate advertisement business information in the pet interactive system 1.

In the exemplary embodiment, the reports and analytics module 18 allows the developer to view administrator activities. One skilled in the art would understand the applicant's design is not the exclusive embodiment.

In the exemplary embodiment, as shown in FIG. 2-4, the plurality of administration user functions 30 includes an admin portal 32. The admin portal 32 provides the administrator access to a hospital profile module 34 and an advertisement customization module 36.

The hospital profile module 34 permits the administrator to have oversight over the hospitals interaction with the pet interactive system 1. One skilled in the art would understand the applicant's design is not the exclusive embodiment.

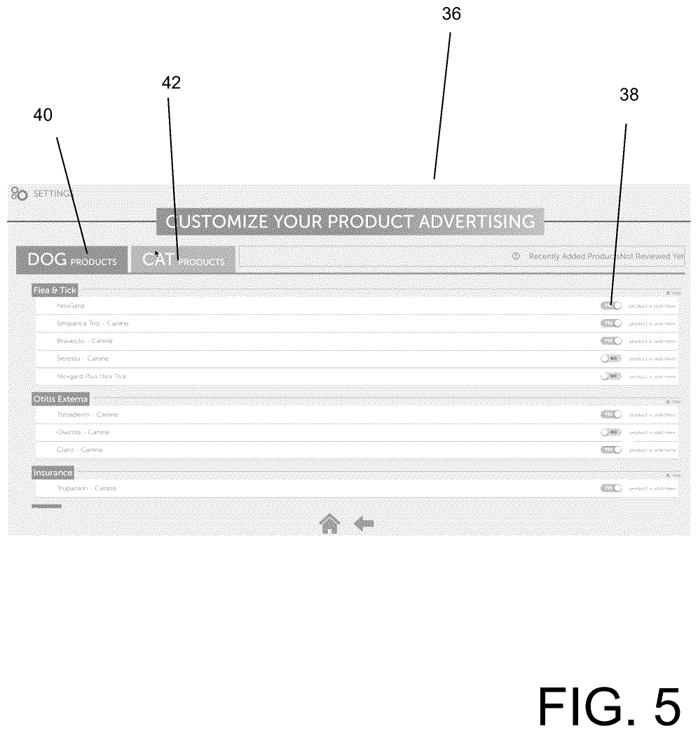

In the exemplary embodiment, as shown in FIG. 5, the advertisement customization module 36 permits the administrator a select/deselect product button 38 corresponding to a sellable product located under a user selectable dog products tab 40 and a user selectable cat products tab 42 which communicates with the computing device 1010 through the database server 1002 and the API. Specifically, the administrator authorizes which sellable products will be advertised by the administrator's business ie. a hospital, veterinary office etc.

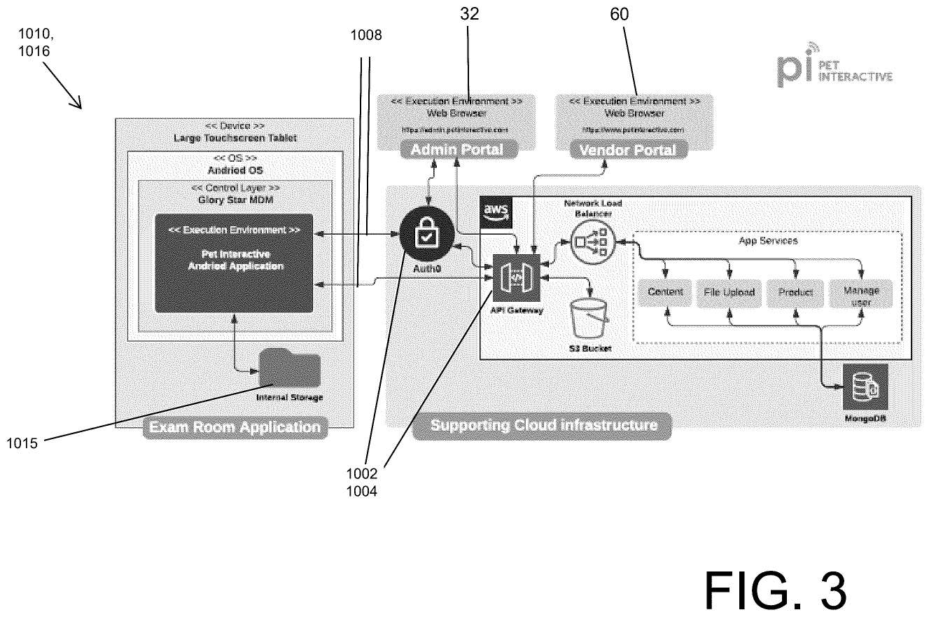

In the exemplary embodiment, as shown in FIGS. 2-3, a plurality of vendor functions 50 is provided for a vendor of the sellable product and allows the vendor to communicate with the pet interactive system 1 through the vendor management module 16.

In the exemplary embodiment and as shown in FIGS. 2-3, the plurality of vendor functions 50 includes an upload product information module 52, a create ad campaign module 54, a track performance module 56 and a pay advertisement bill module 58.

In the exemplary embodiment and as shown in FIG. 2, the upload product information module 52 permits the vendor to upload important product information about the sellable product which is viewable by the administrators and the front-end users.

In the exemplary embodiment and as shown in FIG. 2, the create ad campaign module 54 permits the vendor to upload a plurality of unique media, such as pictures, videos and voice text for displaying and viewing to the front-end users. One skilled in the art would understand the applicant's design is not the exclusive embodiment.

In the exemplary embodiment and as shown in FIG. 2, the track performance module 56 is utilized by the vendor. The track performance module 56 permits the vendor to review details of each of the advertisements associated with the vendor. Additionally, the track performance module 56 permits the vendor to track a plurality of statistics of each advertisement.

In the exemplary embodiment, the pay advertisement bill module 58 permits the vendor to submit payments to the hospital or clinic that displays the advertisements.

In the exemplary embodiment, the plurality of vendor functions 50 are accessible through a vendor portal 60.

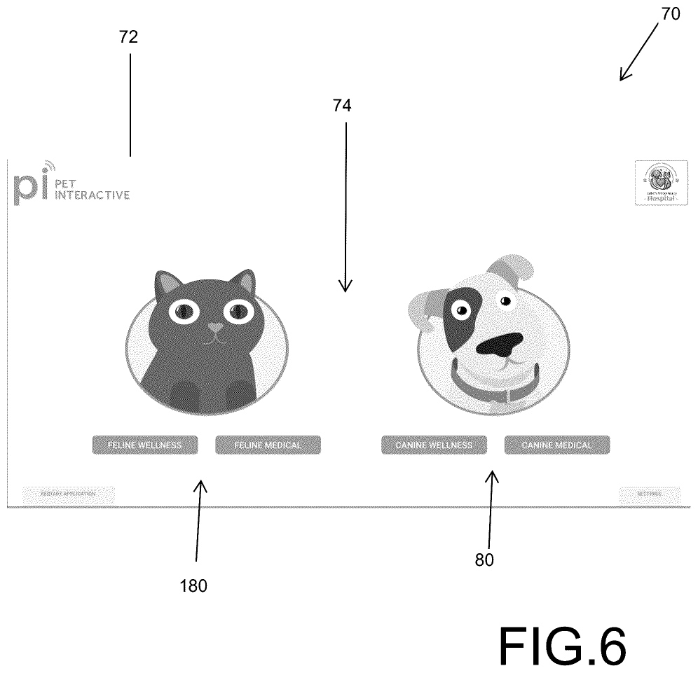

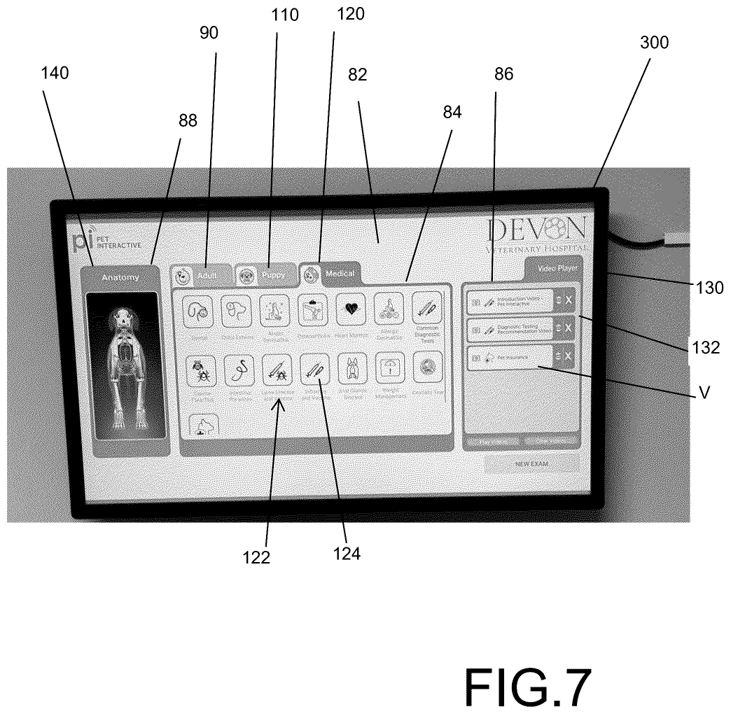

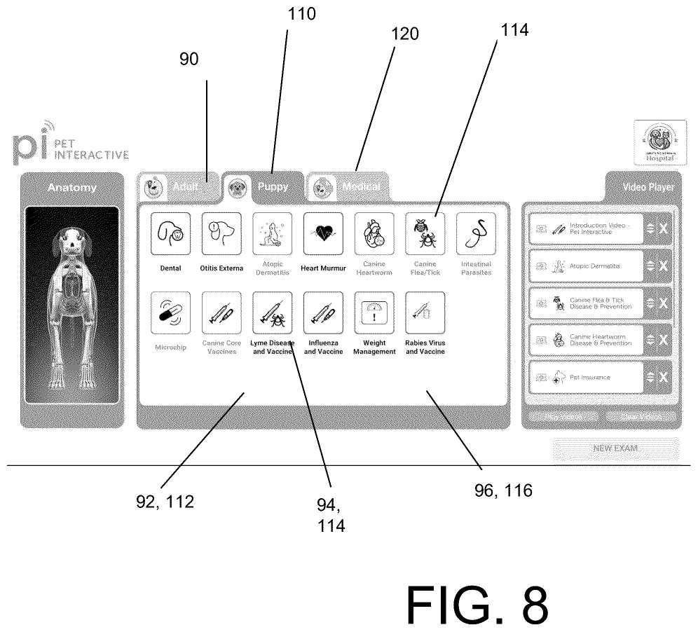

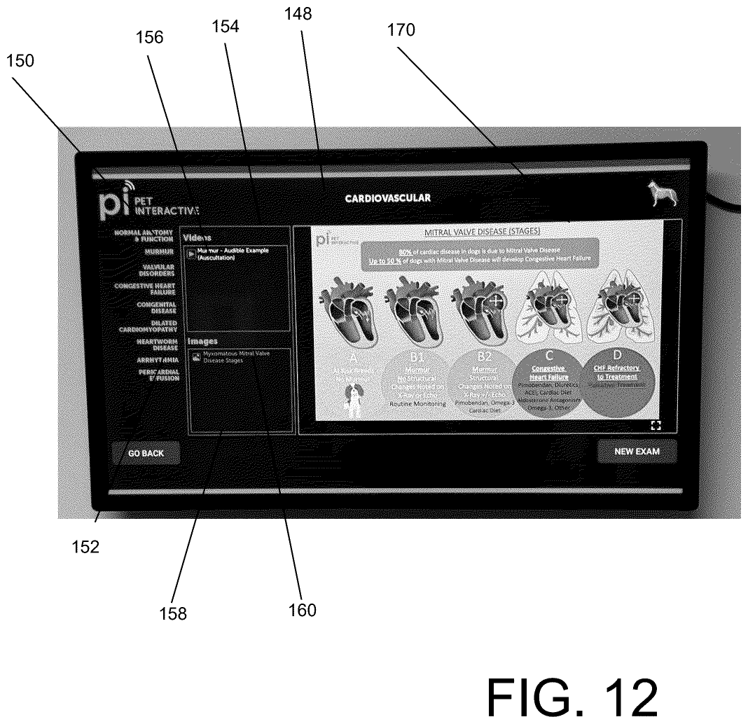

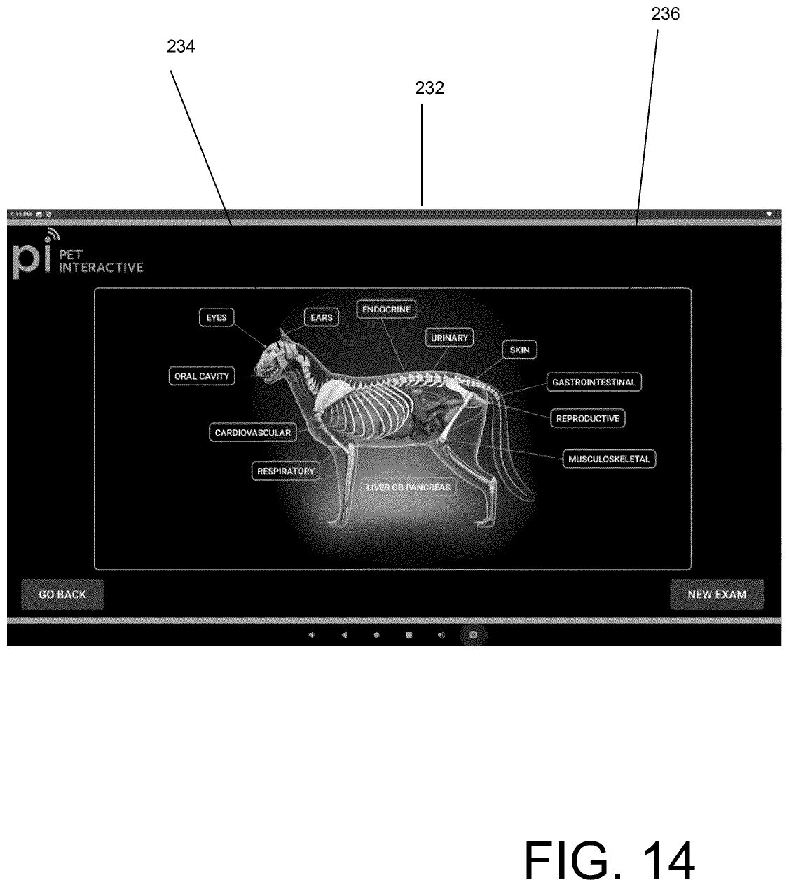

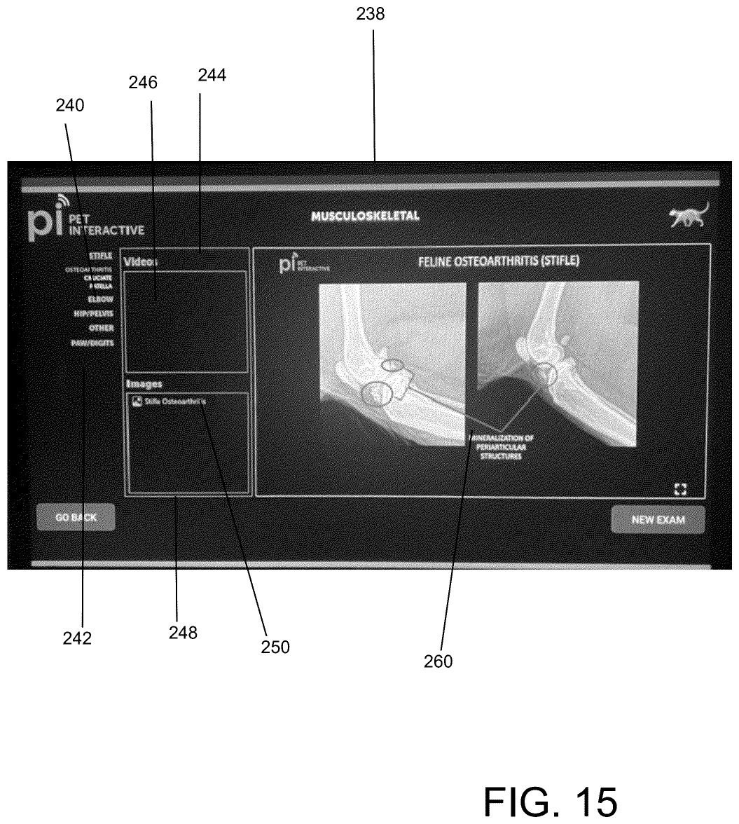

In the exemplary embodiment and as shown in FIGS. 6-15, the front-end user functionality 70 will be described below.

In an exemplary embodiment and as shown in FIG. 6, a main screen module 72 is a large, user-friendly touchscreen display, strategically placed in waiting or consultation rooms. In another exemplary embodiment, the main screen module 72 is a mobile device. One skilled in the art would understand the applicant's design is not the exclusive embodiment.

The main screen module 72 further includes an archival system 74 of the main screen module 72, where the user is provided the option to choose between a canine wellness module 80, a canine medical module 120, a feline wellness module 180 and a feline medical module 210.

In another embodiment, depending on whether the animal is scheduled for a wellness visit or a triage visit, would determine and limit the user to only using the specific module for the animal's visit.

In the exemplary embodiment, the canine wellness module 80 includes a canine health frame 82 with a center column 84, a first outer column 86 and a second outer column 88. One skilled in the art would understand the applicant's design is not the exclusive embodiment.

In the exemplary embodiment, the canine health frame 82 includes an adult canine module 90, a puppy canine module 110, a canine medical module 120, a media player frame 130 and an anatomy module 140.

The adult canine module 90 is a user selectable tab provided on the display or screen 300. The adult canine module 90 includes a plurality of adult canine health modules 92 representing a different topic 94 of health for an adult canine. Each adult canine health module 92 is positioned within a canine wellness module page 96, specifically, the plurality of adult canine health modules 92 are positioned in the center column 84 of the canine health frame 82. Each adult canine health module 92, is selectable, permitting an informational video V to be displayed.

In the exemplary embodiment, the puppy canine module 110 is a user selectable tab. The puppy canine module 110 includes a plurality of puppy canine health modules 112 representing a different topic 114 of health for a puppy canine. Each puppy canine module 110 is positioned within a canine wellness module page 116, specifically, the plurality of puppy canine health modules 112 are positioned in the center column 84 of the canine health frame 82. Each puppy canine health module 112, is selectable, permitting an informational video V to be displayed.

In the exemplary embodiment, the canine medical module 120 is a tab. The canine medical module 120 includes a plurality of medical abnormality modules 122 representing a different topic 124 of medical disorder/abnormality for either an adult canine or a puppy canine. Each canine medical abnormality module 122 is positioned within a canine wellness module page 96, specifically, the plurality of medical abnormality modules 122 are positioned in the center column 84 of the canine health frame 82. Each medical abnormality module 122, is selectable, permitting an informational video V to be displayed.

In the exemplary embodiment, the media player frame 130 permits the informational video V from either the topics 94, 114, 124 of the adult canine module 90, the puppy canine module 110 or the canine medical module 120. The media frame 130 is positioned adjacent to the canine health frame 82, specifically in the first outer column 86. One skilled in the art would understand the applicant's design is not the exclusive embodiment. The informational video V is displayed or queued, along with the appropriate buttons for the user to control the media file playback. The video or audio is positioned within a plurality of columns 132 of the media frame 130. One skilled in the art would understand the applicant's design is not the exclusive embodiment.

In the exemplary embodiment, the anatomy module 140 is positioned adjacent to the canine health frame 82, specifically in the second outer column 88. The anatomy module 140 is selectable, specifically, the anatomy module 140 includes an anatomy frame 142.

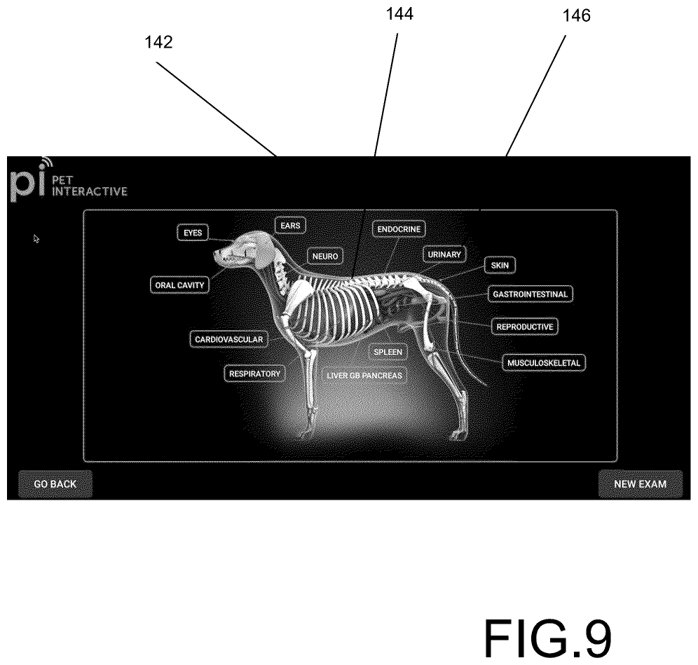

With reference to FIG. 9, the anatomy frame 142 provides a skeletal anatomy 144 of the canine. The skeletal anatomy 144 of the canine provides a plurality of selectable anatomy topics 146. The plurality of selectable anatomy topics 146 are positioned at corresponding areas with respect the skeletal anatomy of the canine.

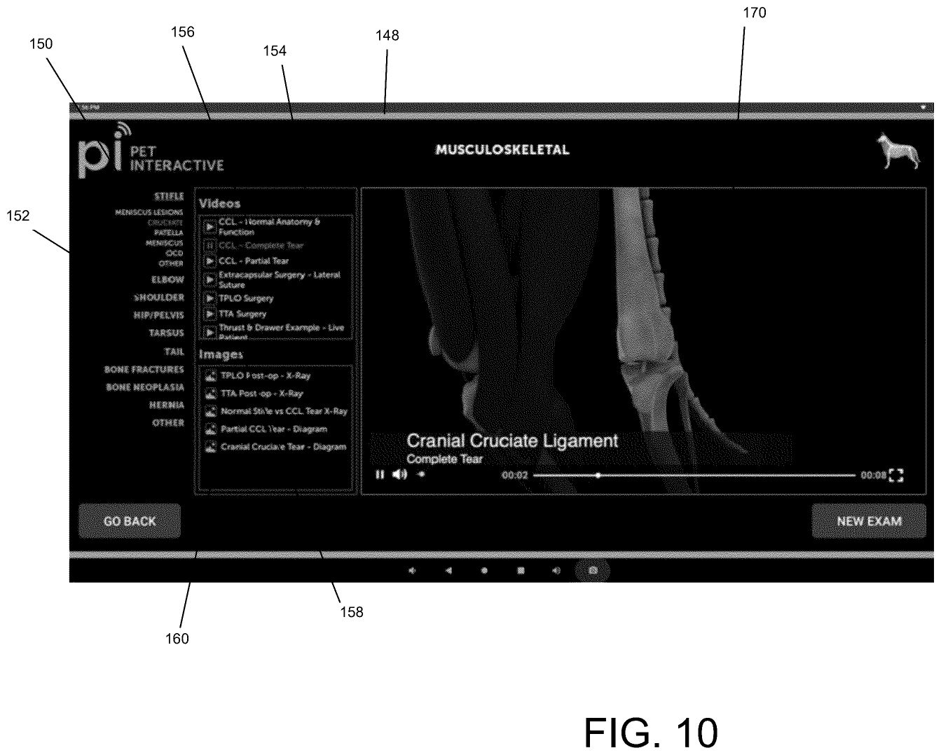

In the exemplary embodiment and as shown in FIG. 10, each selectable anatomy topic 146 produces a topic page 148.

In the exemplary embodiment, the topic page 148 includes a plurality of selectable content 150 associated with the selectable anatomy topic 146. Each selectable content 150 is positioned in a stacked column form 152. One skilled in the art would understand the applicant's design is not the exclusive embodiment.

In the exemplary embodiment, the topic page 148 further includes a video browser screen 154. The video browser screen 154 is positioned adjacent the plurality of selectable content 150. The video browser screen 154 further includes a plurality of selectable videos 156 corresponding to each selectable content 150. In an embodiment, the selectable videos 156 may be non-audio or include audio. One skilled in the art would understand the applicant's design is not the exclusive embodiment.

In the exemplary embodiment, the topic page 148 further includes an image browser screen 158. The image browser screen 158 is positioned adjacent the plurality of selectable content 150. The image browser screen 158 further includes a plurality of selectable images 160 corresponding to each selectable content 150.

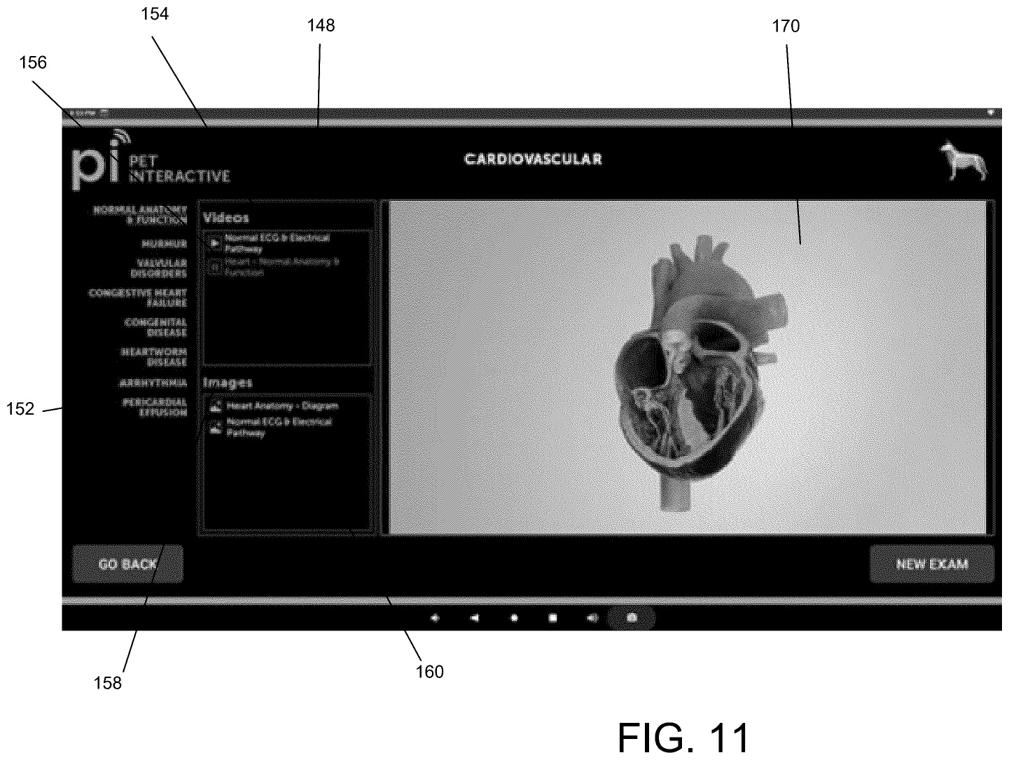

In the exemplary embodiment, as shown in FIG. 11, the topic page 148 further includes a media display 170. The media display 170 is positioned adjacent the video browser screen 154 and the image browser screen 158. The media display 170 permits the plurality of selectable videos 156 or the plurality of selectable images 160 to be shown.

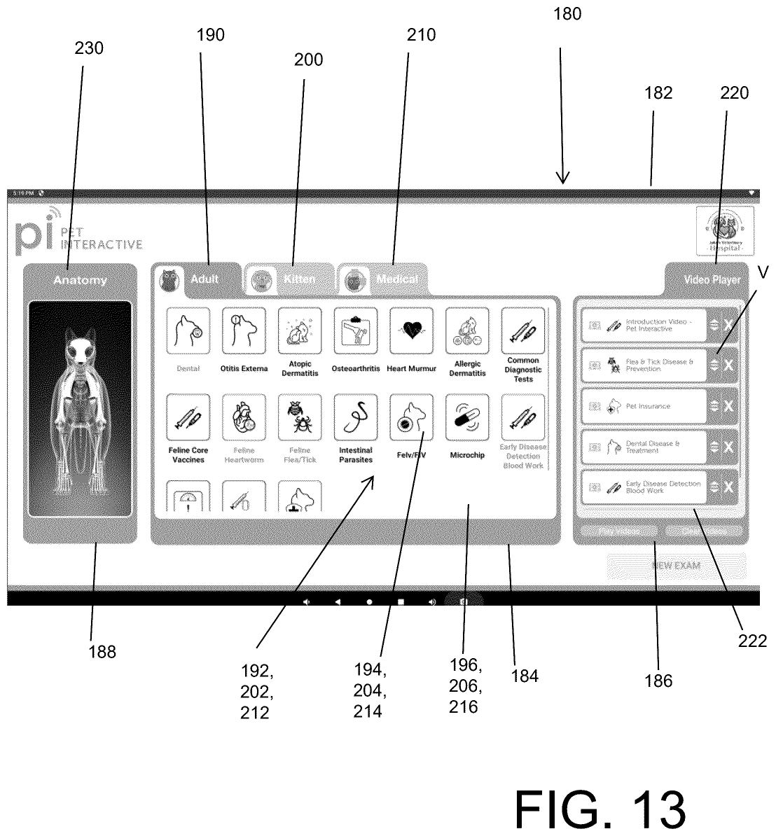

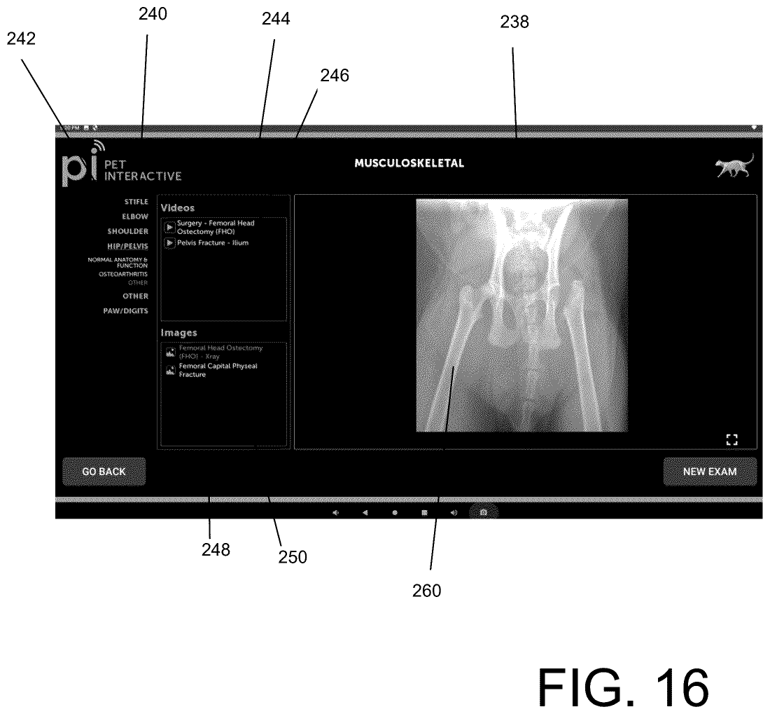

In the exemplary embodiment and as shown in FIGS. 13-16, the feline wellness module 180 mirrors the canine wellness module 80. The feline wellness module 180 includes a feline health frame 182 with a center column 184, a first outer column 186 and a second outer column 188. One skilled in the art would understand the applicant's design is not the exclusive embodiment.

In the exemplary embodiment, the feline health frame 182 includes an adult feline module 190, a kitten feline module 200, a feline medical module 210, a media player frame 220 and an anatomy module 230.

The adult feline module 190 is a selectable tab. The adult feline module 190 includes a plurality of adult feline health modules 192 representing a different topic 194 of health for an adult feline. Each adult feline health module 192 is positioned within a feline wellness module page 196, specifically, the plurality of adult feline health modules 192 are positioned in the center column 184 of the feline health frame 182. Each adult feline module 190 is selectable, permitting an informational video V to be displayed.

In the exemplary embodiment, the kitten feline module 200 is a selectable tab. The kitten feline module 200 includes a plurality of kitten feline health modules 202 representing a different topic 204 of health for a kitten feline. Each kitten feline health module 202 is positioned within a feline wellness module page 206, specifically, the plurality of kitten feline health modules 202 are positioned in the center column 184 of the feline health frame 182. Each kitten feline health module 202 is selectable permitting an informational video V to be displayed.

In the exemplary embodiment, the feline medical module 210 is a selectable tab. The feline medical module 210 includes a plurality of medical feline abnormality modules 212 representing a different topic 214 of medical disorder for either an adult feline or a kitten feline. Each medical feline abnormality module 212 is positioned within a feline wellness module page 216, specifically, the plurality of medical feline abnormality modules 212 are positioned in the center column 184 of the feline health frame 182. Each medical feline abnormality module 212 is selectable, permitting an informational video V to be displayed.

In the exemplary embodiment, the media player frame 220 permits the informational video V from either the topics 194, 204, 214, of the adult feline module 190, the kitten feline module 200 or the feline medical module 210. The media frame 220 is positioned adjacent to the feline health frame 182, specifically in the first outer column 186. One skilled in the art would understand the applicant's design is not the exclusive embodiment. The informational video V is displayed or queued, along with the appropriate buttons for the user to control the media file playback. The video or audio is positioned within a plurality of columns 222 of the media frame 220. One skilled in the art would understand the applicant's design is not the exclusive embodiment.

In the exemplary embodiment, the anatomy module 230 is positioned adjacent to the feline health frame 182, specifically in the second outer column 188. The anatomy module 230 is selectable, specifically, the anatomy module 230 includes an anatomy frame 232.

The anatomy frame 232 provides a skeletal anatomy 234 of the feline. The skeletal anatomy 234 of the feline provides a plurality of selectable anatomy topics 236. The plurality of selectable anatomy topics 236 are positioned at corresponding areas with respect to the skeletal anatomy of a feline.

In the exemplary embodiment, each selectable anatomy topic 236 produces a topic page 238.

In the exemplary embodiment, the topic page 238 includes a plurality of selectable content 240 associated with the selectable anatomy topic 236. Each selectable content 240 is positioned in a stacked column form 242. One skilled in the art would understand the applicant's design is not the exclusive embodiment.

In the exemplary embodiment, the topic page 238 further includes a video browser screen 244. The video browser screen 244 is positioned adjacent the plurality of selectable content 240. The video browser screen 244 further includes a plurality of selectable videos 246 corresponding to each selectable content 240. The plurality of selectable videos 246 may be non-audio or audio. One skilled in the art would understand the applicant's design is not the exclusive embodiment.

In the exemplary embodiment, the topic page 238 further includes an image browser screen 248. The image browser screen 248 is positioned adjacent the plurality of selectable content 240. The image browser screen 248 further includes a plurality of selectable images 250 corresponding to each selectable content 240.

In the exemplary embodiment, the topic page 238 further includes a media display 260. The media display 260 is positioned adjacent the video browser screen 244 and the image browser screen 248. The media display 260 permits the plurality of selectable videos 246 or the plurality of selectable images 250 to be shown.

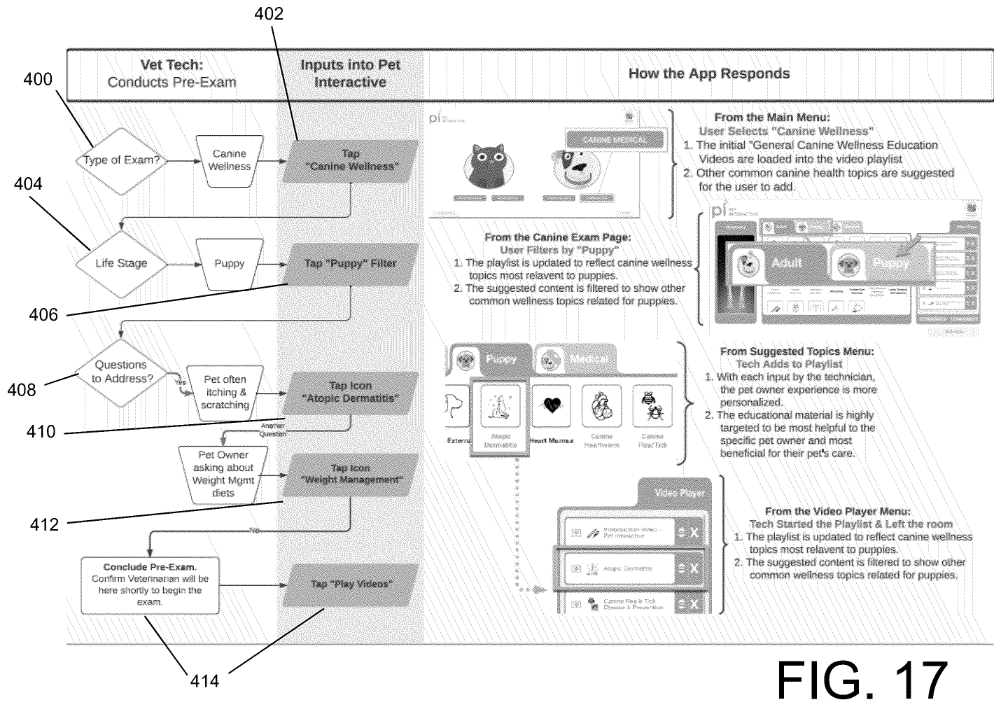

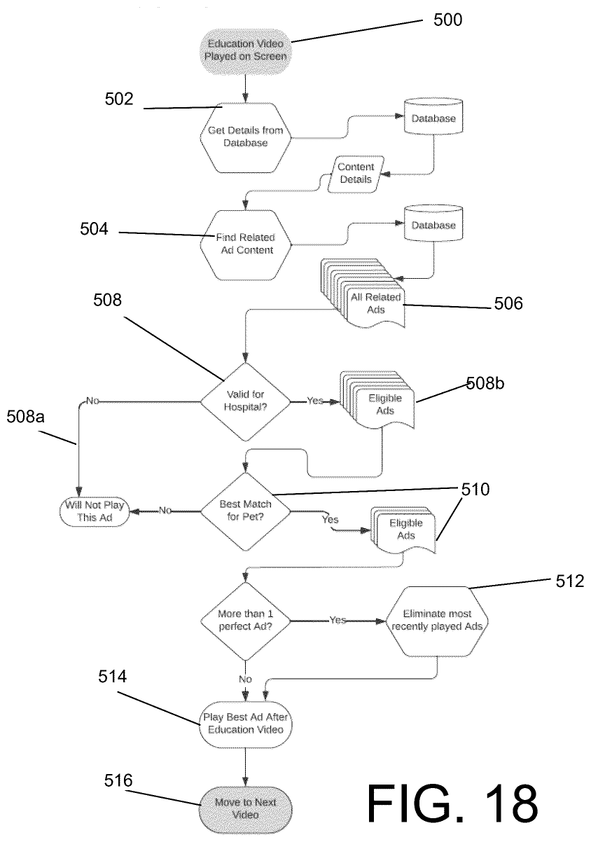

In the exemplary embodiment and as shown in FIGS. 17-18, the computing device 1010 includes a screen 300 which may be provided in an examination room, allowing the pet interactive system 1 to be utilized.

In the exemplary embodiment and as shown in FIG. 17 in diagram form, the user, for example a veterinarian technician, will determine the type of exam for the pet of the pet owner as shown as step 400. The user will then tap the appropriate selectable tab as shown as step 402. The user will then tap the appropriate selectable life stage tab ie, puppy, adult dog, kitten, adult cat as shown as step 404 and select the appropriate tab as shown as step 406. The user will ask the pet owner questions (as shown as step 408) about the pet to determine which video or media to select as shown as step 410. If the pet owner has multiple questions, the user will select another video or media as shown as step 412. Each informational video V or media chosen by the veterinary technician is queued in the media player frame 130, 220. Additionally, the veterinary technician is permitted to rearrange the order of the informational videos V within the media player frame 130, 220.

The user will conclude the pre-examination and proceed with playing the selected media as shown as step 414.

In the exemplary embodiment, the algorithm controls and selects an eligible advertisement based on an established criteria as shown.

In the exemplary embodiment and as shown in FIG. 18 in diagram form, an algorithm receives details from the data base of the pet interactive system 1 as shown as step 502. Step 502 is performed during the presentation of the selected media or video V.

In the exemplary embodiment, the algorithm retrieves related advertisement content that correlates to the specific content of the media or informational video V that is currently displayed on the screen 300 as shown as step 504,506.

In the exemplary embodiment, the algorithm sorts the retrieved advertisements into appropriate categories as shown as step 508. The programable algorithm regulates the retrieved advertisements according to the selections by the hospital through the advertisement customization module 36. The algorithm sorts whether the advertisement is an unapproved advertisement as shown as step 508a or an approved advertisement as shown as step 508b.

In the exemplary embodiment, the algorithm sorts the approved advertisements into a further category of whether the approved advertisement is related to the media or informational video being displayed for the pet owner as shown as step 510.

In the exemplary embodiment, the algorithm will recall the number of repeats each approved advertisement was displayed, simultaneously, the algorithm will eliminate the most recently played advertisements as shown as step 512. Specifically, from the list of approved advertisements, the algorithm determines the number of times each advertisement has been played over a business quarter or determined timeframe in the specific veterinary hospital or clinic.

In the exemplary embodiment, the algorithm will further target advertisements that have been displayed the least number of times over the specified time frame such as a business quarter, monthly, weekly, daily, etc. The algorithm will then queue and further display the appropriate advertisement after the particular video V has concluded as shown as step 514. The process will repeat for the next video as shown as step 516 and continue to repeat until all selected videos or media has ceased in the queue.

In another exemplary embodiment, if a pet has lapsed or is due for certain medication, for example, heart worm disease prevention medication, the algorithm may receive data from the pet interactive system 1 and perform a similar process as discussed previously above i.e., provide a targeted advertisement to the pet owner once the educational video V has concluded.

In the exemplary embodiment, once the veterinarian enters the waiting room, the veterinarian may pause the video V. During the examination, the Veterinarian may provide examples and illustrations to the pet owner by utilizing the selectable tabs within the canine wellness module 80 or the feline wellness module 180 or the corresponding anatomy module 140, 230.

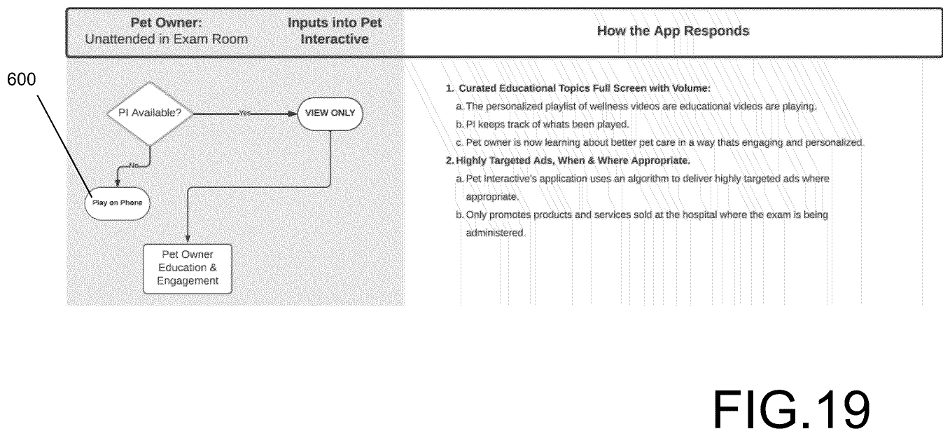

In the exemplary embodiment and as shown in FIG. 19, the pet owner may access the pet interactive system I using a mobile application or there may be a QR code accessible within the waiting area of the veterinary hospital waiting room as shown as 600. One skilled in the art would understand the applicant's design is not the exclusive embodiment.

It should be noted that various changes and modifications to the embodiments described herein will be apparent to those skilled in the art. Such changes and modifications may be made without departing from the spirit and scope of the present invention and without diminishing its intended advantages. For example, various embodiments of the systems and methods may be provided based on various combinations of the features and functions from the subject matter provided herein.

What is claimed is:

1. A pet interactive system comprising:
a computing device includes a screen and a network traffic information on a database server;
a content management module coupling to the computing device through a network interface, permitting a developer to create or change content displayed on the screen;
a plurality of vendor functions communicating with a vendor management module of the developer;
the content management module further permits and communicates with a pet health module having a plurality of selectable topics displayable on the screen; each selectable topic of the plurality of selectable topics corresponds to a video;
an advertisement customization module permits an administrator a select/deselect product button corresponding to a sellable product of a vendor which communicates with the computing device;
a criteria utilized by an algorithm when determining an appropriate advertisement to play once the video concludes, the criteria determines from a plurality of approved advertisements by the administrator, a nature of an advertisement, a review of a number of times the advertisement is played through a specified time frame, and narrows down the plurality of approved advertisements to present the appropriate advertisement to correspond to a videos conclusion.

2. The pet interactive system of claim 1, wherein the pet health module includes an adult canine module.

3. The pet interactive system of claim 2, wherein the pet health module includes a puppy canine module.

4. The pet interactive system of claim 3, wherein the pet health module includes a canine medical module.

5. The pet interactive system of claim 4, wherein the pet health module includes an adult feline module.

6. The pet interactive system of claim 5, wherein the pet health module includes a kitten feline module.

7. The pet interactive system of claim 6, wherein the pet health module includes a feline medical module.

8. The pet interactive system of claim 7, wherein the pet health module includes an anatomy module.

9. The pet interactive system of claim 8, wherein the anatomy module includes a skeletal anatomy.

10. The pet interactive system of claim 9, wherein the skeletal anatomy includes a plurality of selectable anatomy topics.

11. The pet interactive system of claim 10, wherein each selectable anatomy topic produces a separate topic page.

12. The pet interactive system of claim 11, wherein each separate topic page includes a plurality of selectable content.

13. The pet interactive system of claim 12, wherein each selectable content includes a selectable video.

14. The pet interactive system of claim 13, wherein each selectable content includes a selectable image.

15. The pet interactive system of claim 14, wherein the pet interactive system further comprises a vendor portal.

16. The pet interactive system of claim 15, wherein the pet interactive system further comprises a developer portal to aid in customization of front-end user content.

17. The pet interactive system of claim 16, wherein the developer portal further includes customization of vendor advertisers associated with the pet interactive system.
